(19) United States
(12) Patent Application Publication
(10) Pub. No.: US 2020/0223408 A1
(43) Pub. Date: Jul. 16, 2020

(54) BRAKE APPARATUS, CONTROL APPARATUS FOR VEHICLE, AND ELECTRIC BRAKE CONTROL APPARATUS

(71) Applicant: HITACHI AUTOMOTIVE SYSTEMS, LTD., Hitachinaka-shi, Ibaraki (JP)

(72) Inventors: Daisuke GOTO, Atsugi-shi, Kanagawa (JP); Chiharu NAKAZAWA, Kawasaki-shi, Kanagawa (JP); Takahiro ITO, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/648,330

(22) PCT Filed: Sep. 19, 2018
(86) PCT No.: PCT/JP2018/034545

§ 371 Date: Mar. 18, 2020

(30) Foreign Application Priority Data
Sep. 27, 2017 (JP) 2017-185740

(51) Int. Cl. B60T 8/17; B60T 7/04; F16D 65/16; B60T 8/172; B60T 13/58; B60T 8/171; B60T 8/32; B60T 13/66; B60T 13/74; B60T 8/58

(52) U.S. Cl. CPC B60T 8/17; F16D 2121/04; F16D 65/16; B60T 8/172; B60T 13/58; B60T 8/171; B60T 8/3255; B60T 13/66; B60T 13/741; B60T 8/58; B60T 2250/03; B60T 2250/00; B60T 2240/00; B60T 2220/04; B60T 2270/82; B60T 7/042

(57) ABSTRACT

A brake apparatus including a hydraulic brake mechanism, an electric brake mechanism, and first and second controllers. The hydraulic brake mechanism can apply a braking force by thrusting a braking member forward with use of hydraulic pressure to a wheel belonging to a first group among a plurality of wheels of the vehicle. The electric brake mechanism can apply a braking force by thrusting a braking member forward with use of an electric motor to a wheel belonging to a second group among the plurality of wheels. The first controller can control the hydraulic brake mechanism, and the second controller can control the electric brake mechanism. The first controller acquires or receives at least one of yaw rate information of the vehicle and acceleration information of the vehicle without intervention of the second controller. The second controller acquires or receives wheel speed information without intervention of the first controller.

### TECHNICAL FIELD

The present invention relates to a brake apparatus.

### BACKGROUND ART

Conventionally, there has been known a brake apparatus including a front wheel brake mechanism and a rear wheel brake mechanism as disclosed in PTL 1. This brake apparatus is employed for a vehicle including a wheel speed sensor capable of detecting a wheel speed of each wheel and a vehicle body speed sensor capable of detecting a vehicle body speed of the vehicle. The wheel speed sensor that detects a wheel speed of a front wheel is connected to a first controller capable of controlling the front wheel brake mechanism. The wheel speed sensor that detects a wheel speed of a rear wheel is connected to a second controller capable of controlling the rear wheel brake mechanism. The brake apparatus is configured in such a manner that each of the first controller and the second controller can acquire the vehicle body speed information detected by the vehicle body speed sensor.

### CITATION LIST

### Patent Literature

[PTL 1] Japanese Patent Application Public Disclosure No. 2002-67909

### SUMMARY OF INVENTION

### Technical Problem

Some of recent vehicles are equipped with an acceleration sensor and a yaw rate sensor instead of the vehicle body speed sensor to realize an ESC function for preventing a sideslip of the vehicle. This case leads to the necessity of estimating the vehicle body speed information used to realize an ABS function for preventing a lock of a wheel with use of a plurality of pieces of wheel speed information. Employing the conventional brake apparatus for such a vehicle raises a possibility that, when an abnormality has occurred in the front wheel side or the rear wheel side, a controller on a normal side on which the abnormality has not occurred cannot sufficiently acquire the wheel speed information and thus cannot estimate the vehicle body speed information, thereby resulting in a failure to lock the wheel.

### Solution to Problem

According to one aspect of the present invention, a brake apparatus includes a first controller and a second controller. The first controller acquires or receives at least one of yaw rate information of a vehicle and acceleration information of the vehicle without intervention of the second controller. Further, the second controller acquires or receives wheel speeds of a plurality of wheels without intervention of the first controller.

Even when the abnormality has occurred in one of the controllers, the brake apparatus can brake the vehicle while stabilizing the behavior of the vehicle.

### BRIEF DESCRIPTION OF DRAWINGS

FIG. 1 illustrates an overall configuration of a brake system according to a first embodiment.

FIG. 2 illustrates a configuration of a control system of a rear wheel brake device according to the first embodiment.

FIG. 3 illustrates an overall flow of braking force control according to the first embodiment.

FIG. 4 illustrates a flow of all wheel braking force control corresponding to when the brake system is normal according to the first embodiment.

FIG. 5 illustrates a flow of front wheel braking force control corresponding to when a failure has occurred in a rear wheel according to the first embodiment.

FIG. 6 illustrates a flow of rear wheel braking force control corresponding to when a failure has occurred in a front wheel according to the first embodiment.

FIG. 7 illustrates processing in the braking force control that is assigned to and performed by a rear ECU according to one example of the first embodiment.

FIG. 8 illustrates processing in the braking force control that is assigned to and performed by a front ECU according to one example of the first embodiment.

FIG. 9 illustrates processing assigned to and performed by the rear ECU in the all wheel braking force control corresponding to when the brake system is normal according to one example of the first embodiment.

FIG. 10 illustrates processing assigned to and performed by the front ECU in the all wheel braking force control corresponding to when the brake system is normal according to one example of the first embodiment.

FIG. 11 illustrates a configuration of a control system of a rear wheel brake device according to a second embodiment.

FIG. 12 illustrates a configuration of a control system of a rear wheel brake device according to a third embodiment.

### DESCRIPTION OF EMBODIMENTS

In the following description, embodiments for implementing the present invention will be described with reference to the drawings.

### First Embodiment

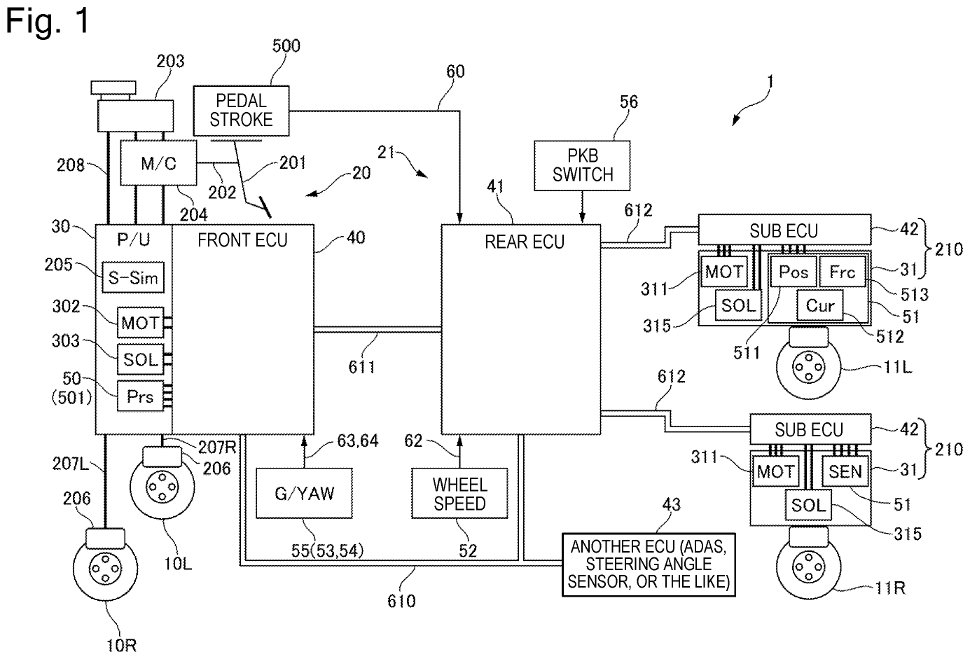

First, an overall configuration of a brake system 1 of a vehicle according to the present embodiment will be described with reference to FIG. 1. The brake system 1 can be employed for a vehicle such as an engine automobile, a hybrid automobile, and an electric automobile. The vehicle includes a plurality of (four) wheels. Front wheels 10 belonging to a first group, among the plurality of wheels, include a front left wheel 10L and a front right wheel 10R. Rear wheels 11 belonging to a second group different from the first group, among the plurality of wheels, include a rear left wheel 11L and a rear right wheel 11R. The brake system 1 includes a brake device 20 on the front wheel 10 side (a front wheel brake device) and a brake device 21 on the rear wheel 11 side (a rear wheel brake device).

First, the front wheel brake device 20 will be described. The front wheel brake device 20 includes a brake pedal 201, an input rod 202, a reservoir tank 203, a master cylinder 204, a hydraulic bake mechanism 30, a stroke simulator 205, a front ECU 40, and a stroke sensor 500. The brake pedal 201 is a brake operation member to which a brake operation performed by a driver of the vehicle is input. The brake pedal 201 is connected to the master cylinder 204 via the input rod 202. The stroke sensor 500 detects a rotational angle of the brake pedal 201. This rotational angle corresponds to a stroke of the brake pedal 201 (a pedal stroke). The pedal stroke corresponds to an amount of the operation on the brake pedal 201 performed by the driver (a brake operation amount). The stroke sensor 500 functions as a brake operation amount detection unit that detects the brake operation amount or an operation amount measurement portion that measures the brake operation amount (an operation amount detector). The detected pedal stroke may be a stroke of the input rod 202 connected to the master cylinder 204. The reservoir tank 203 stores therein brake fluid (hydraulic fluid). The reservoir tank 203 is mounted on the master cylinder 204, and can replenish the brake fluid to the master cylinder 204. The master cylinder 204 generates a pressure of the brake fluid (a master cylinder pressure) according to the brake operation. The master cylinder 204 is connected to a wheel cylinder (a brake cylinder) 206 of each of the front wheels 10 via a brake pipe 207. The brake pipe 207 is prepared for each system (the front left wheel 10L and the front right wheel 10R). The wheel cylinder 206 is a hydraulic caliper, and thrusts a piston forward with use of a hydraulic pressure supplied via the brake pipe 207. The wheel cylinder 206 presses a brake pad as a braking member against a brake rotor with the aid of the advancement of the piston, thereby applying a frictional braking force to the front wheel 10.

The hydraulic brake mechanism 30 is a hydraulic control unit capable of applying a braking force to each of the front wheels 10 with use of the hydraulic pressure. The hydraulic brake mechanism 30 is located at an intermediate position of the brake pipe 207. The hydraulic brake mechanism 30 is connected to the reservoir tank 203 via a brake pipe 208. A housing of the hydraulic brake mechanism 30 includes a plurality of fluid passages therein, and contains a plurality of valves, a pump, and a plurality of hydraulic sensors 50. Each of the valves can control opening/closing of the fluid passage. Some of the valves are solenoid valves, and are driven by solenoids 303. The pump is, for example, a plunger pump, and can supply the hydraulic pressure by discharging the brake fluid to the fluid passage. The pump is driven by a motor (an electric motor) 302. The motor 302 is, for example, a brushed DC motor. The plurality of fluid passages forms a hydraulic circuit. The hydraulic brake mechanism 30 can supply arbitrary hydraulic pressures to the wheel cylinders 206 of the front wheels 10L and 10R and can also control the above-described hydraulic pressures at the front wheels 10L and 10R independently of each other by actuating the pump and the valves. For example, the hydraulic brake mechanism 30 can supply hydraulic pressures different from each other to the respective wheel cylinders 206 by actuating the pump and an adjustment valve to generate an initial pressure, and controlling opening/closing a pressure increase valve and a pressure reduction valve corresponding to each of the wheel cylinders 206 in this state. The motor 302 may be a three-phase DC brushless motor.

The plurality of hydraulic sensors 50 includes system pressure sensors and a master cylinder pressure sensor 501. The system pressure sensors include a sensor capable of detecting a pressure in a fluid passage in communication with the wheel cylinder 206 of the front left wheel 10L, and a sensor capable of detecting a pressure in a fluid passage in communication with the wheel cylinder 206 of the front right wheel 10R. The master cylinder pressure sensor 501 can detect a pressure in a fluid passage in communication with a pressure chamber in the master cylinder 204 (the master cylinder pressure). The master cylinder pressure corresponds to a force pressing the brake pedal 201 (a pedal pressing force) or an amount of the pressing of the brake pedal 201 (the pedal stroke). The pedal pressing force and the pedal stroke correspond to the brake operation amount. The master cylinder pressure sensor 501 functions as the brake operation amount detection unit or the operation amount measurement portion (the operation amount detector). The detected pedal pressing force may be a pressing force directly applied to the brake pedal 201 or may be an axial force of the input rod 202.

The front ECU 40 is a first controller, which is mounted in the housing of the hydraulic brake mechanism 30 and can control the hydraulic brake mechanism 30. The front ECU 40 includes a CPU, a driving circuit, and an interface circuit. The driving circuit includes a solenoid driving circuit and a motor driving circuit. The interface circuit receives inputs of signals from the stroke sensor 500, the hydraulic sensors 50, and another sensor, and a signal from another ECU. These CPU, driving circuit, and interface circuit, and the like function as a first control circuit capable of controlling the hydraulic brake mechanism 30, and can control each hydraulic pressure to be supplied to the wheel cylinder 206 of each of the front wheels 10L and 10R by controlling the motor 302 and the solenoid 303 based on the input signals.

The stroke simulator 205 is mounted in the housing of the hydraulic brake mechanism 30, and can communicate with the pressure chamber in the master cylinder 204. The stroke simulator 205 is actuated by introducing therein the brake fluid flowing out from the pressure chamber in the master cylinder 204, and can generate a reaction force of the brake operation. The front ECU 40, for example, generates the reaction force according to the brake operation by bringing the stroke simulator 205 into communication with the pressure chamber in the master cylinder 204 with the master cylinder 204 and the wheel cylinder 206 out of communication with each other.

The hydraulic brake mechanism 30 blocks the communication between the master cylinder 204 and the stroke simulator 205 through the hydraulic circuit, and establishes the communication between the master cylinder 204 side and the wheel cylinder 206 side when the hydraulic control is impossible, such as when a failure has occurred in the front ECU 40 and when a failure has occurred in an actuator (the motor 302 and the like). This allows the master cylinder pressure to be supplied to each of the wheel cylinders 206, thereby allowing the braking force to be applied to each of the front wheels 10 according to the brake operation.

Next, the rear wheel brake device 21 will be described. The rear wheel brake device 21 includes an electric brake device 210, a rear ECU 41, and a parking brake switch 56. The electric brake device 210 is disposed on each of the rear left and right wheels 11L and 11R. The electric brake device 210 includes an electric brake mechanism 31 and a sub ECU 42.

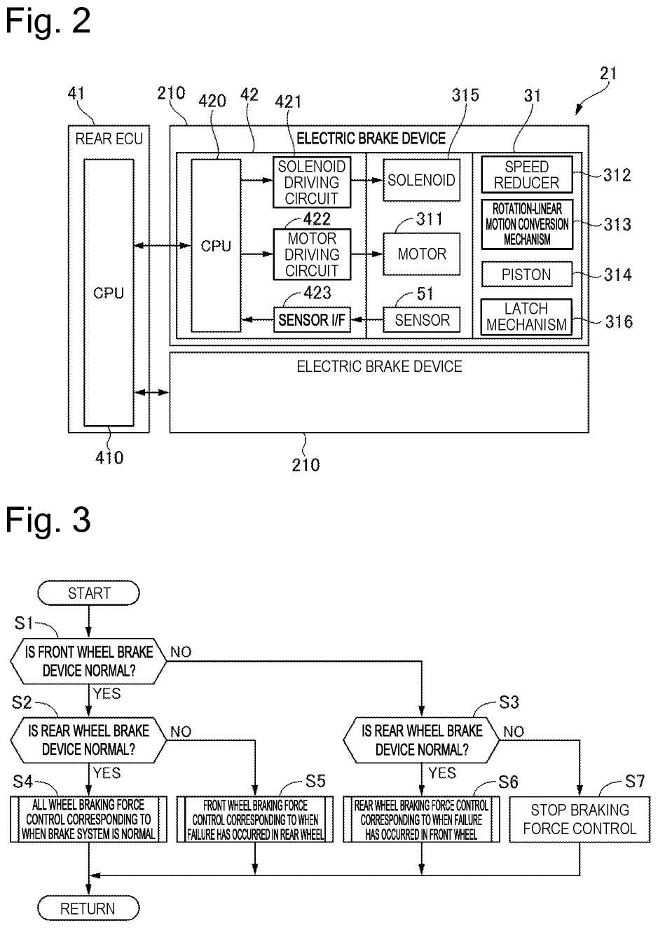

The electric brake mechanism 31 is an electric caliper, and thrusts the braking member forward with use of an electric motor. That is, the electric brake mechanism 31 can apply a frictional braking force to each of the rear wheels 11 by pressing the brake pad as the braking member against the brake rotor. More specifically, as illustrated in FIGS. 1 and 2, the electric brake mechanism 31 includes a motor 311 as the electric motor, a speed reducer 312, a rotation-linear motion conversion mechanism 313, a piston 314, a solenoid 315, a latch mechanism 316, and a plurality of sensors 51. The motor 311 is, for example, a three-phase DC brushless motor, and includes a resolver capable of detecting a rotational angle of a rotor of the motor 311. The speed reducer 312 is, for example, a differential gear speed reduction mechanism, and transmits the rotation output from the motor 311 to the rotation-linear motion conversion mechanism 313 while slowing down it. The rotation-linear motion conversion mechanism 313 is, for example, a ball screw mechanism, and transmits the rotational motion of the motor 311 (the speed reducer 312) to the piston 314 while converting it into a linear motion. The piston 314 can abut against a back surface of the brake pad. Hereinafter, a force that the piston 314 is thrust forward to press the brake pad will be referred to as a piston thrust force. The piston thrust force corresponds to the braking force on the rear wheel 11. The latch mechanism 316 can hold the piston thrust force by being engaged with a claw provided on the rotor of the motor 311 even with the motor 311, for example, in a state that electric power is not supplied thereto. The solenoid 315 is configured to be able to drive the latch mechanism 316. The solenoid 315 and the latch mechanism 316 function as a parking brake mechanism. The plurality of sensors 51 includes a position sensor 511, an electric current sensor 512, and a thrust force sensor 513. The position sensor 511 can detect a position of the piston 314. The electric current sensor 512 can detect an electric current of the motor 311. The thrust force sensor 513 can detect the piston thrust force. The electric current of the motor 311 corresponds to the piston thrust force, and therefore the electric brake mechanism 31 may be configured to omit the thrust force sensor 513 therefrom and estimate the piston thrust force based on the electric current of the motor 311. More specifically, for example, the apparatus discussed in Japanese Patent Application Public Disclosure No. 2006-105170 or 2006-183809 may be employed as the electric brake mechanism 31. The electric brake mechanisms 31 of the rear wheels 11L and 11R can generate the piston thrust forces by actuating the respective motors 311 and can also hold the piston thrust forces by actuating the respective latch mechanisms 316 independently of each other.

A configuration of a control system of the rear wheel brake device 21 will be described with reference to FIG. 2. The rear wheel brake device 21 includes one rear ECU 41. A casing (a housing) of the rear ECU 41 may be a different member from the case of the front ECU 40 or may be a member shared with the front ECU 40. In the case where the casing is shared between the rear ECU 41 and the front ECU 40, a substrate of the rear ECU 41 may be a different member from a substrate of the front ECU 40 or may be a member shared with the front ECU 40. The sub ECU 42 is mounted in the housing of each of the electric brake mechanisms 31. The rear ECU 41 and the sub ECU 42 are connected communicably with each other via a dedicated communication line (a signal line) 612. The rear ECU 41 and the sub ECU 42 are a second controller capable of controlling the electric brake mechanism 31. The rear ECU 41 includes a superior CPU 410 and an interface circuit. The interface circuit receives signals from the parking brake switch 56 and another sensor, and a signal from another ECU. The sub ECU 42 includes a subordinate CPU 420, a driving circuit, and an interface circuit. The driving circuit includes a solenoid driving circuit 421 and a motor driving circuit 422. A wiring leading to the solenoid 315 is connected to the solenoid driving circuit 421. A wiring leading to the motor 311 is connected to the motor driving circuit 422. The interface circuit includes an interface circuit 423 to which a signal line of the sensor is connected, and also receives an input of a signal from the CPU 410. The CPU 420 controls the motor 311 and the solenoid 315 (of the electric brake mechanism 31 on which this sub ECU 42 is mounted) based on signals from the CPU 410, the sensors 51, and the like input via the interface circuit. Due to this control, the CPU 420 can control the piston thrust force (of this electric brake mechanism 31) and the actuation of the latch mechanism 316. For example, the CPU 420 calculates a target electric current value of the motor 311 according to a braking force instruction directed to the rear wheel 11 that is input from the CPU 410, and calculates a duty ratio according to this target electric current value. The CPU 420 outputs an instruction signal indicating this duty ratio to the motor driving circuit 422. Further, the CPU 420 detects or estimates an actual braking force (a real braking force) on the rear wheel 11 based on the signal from the sensor 51, and adds a control signal according to a difference between the braking force instruction and the actual braking force to the above-described instruction signal. The motor driving circuit 422 supplies electric power to the motor 311 according to an instruction signal as a result of the above-described addition. As a result, the piston thrust force is generated so as to correct the actual braking force on the rear wheel 11 closer to the braking force instruction. In this manner, the CPU 410, the CPU 420, the driving circuits 421 and 422, the interface circuit 423, and the like function as a second control circuit capable of controlling the electric brake mechanism 31.

The interface circuits of the ECU 40 to the ECU 42 may be software in the CPU.

As illustrated in FIG. 1, a plurality of sensors (detectors) in the vehicle is connected to the front ECU 40 and the rear ECU 41. This plurality of sensors includes a wheel speed sensor 52, an acceleration sensor 53, a yaw rate sensor 54, and a steering angle sensor. The wheel speed sensor 52 is disposed on each of the wheels 10L, 10R, 11L, and 11R, and detects a rotational angular speed (a wheel speed) of each of the wheels 10L, 10R, 11L, and 11R. The wheel speed sensor 52 functions as a wheel speed detector, or a wheel speed measurement portion that measures the wheel speed. The acceleration sensor 53 detects an acceleration in a longitudinal (front-rear) direction of the vehicle (a longitudinal G) and an acceleration in a lateral (left-right) direction of the vehicle (a lateral G). The acceleration sensor 53 functions as an acceleration detector, or an acceleration measurement portion that measures the acceleration of the vehicle. Now, the acceleration also includes a deceleration. The yaw rate sensor 54 detects a yaw rate of the vehicle. The yaw rate sensor 54 functions as a yaw rate detector, or a yaw rate measurement portion that measures the yaw rate of the vehicle. The sensors 53 and 54 are integrated as a combined sensor 55. The steering angle sensor detects a steering angle input by the driver.

The front ECU 40 and the rear ECU 41 are connected communicably with each other via a dedicated communication line (a signal line) 611. The front ECU 40 can transmit the acquired or received (hereinafter referred to as simply “acquired”) sensor signal and the calculated instruction signal to the rear ECU 41 via the communication. Further, the rear ECU 41 can transmit the acquired sensor signal and the calculated instruction signal to the front ECU 40 via the communication. Further, the front ECU 40 and the rear ECU 41 are connected communicably with another ECU 43 (an ECU of an advanced driver-assistance system ADAS in charge of, for example, autonomous brake control) via an in-vehicle communication network (CAN) 610. The ECUs 40 and 41 can acquire a signal of the steering angle sensor (steering angle information) and an autonomous brake instruction from the ECU 43.

The master pressure sensor 501 is connected to the front ECU 40 directly (without intervention of another ECU). The rear ECU 41 does not exist in a route through which a signal of the master cylinder pressure sensor 501 is transmitted. The front ECU 40 acquires pedal pressing force information without intervention of the rear ECU 41. Further, signal lines of the combined sensor 55 (a signal line 63 of the acceleration sensor 53 and a signal line 64 of the yaw rate sensor 54) are directly connected to the front ECU 40. The rear ECU 41 does not exist in a route through which signals of the yaw rate sensor 54 and the acceleration sensor 53 are transmitted. The front ECU 40 acquires the yaw rate information of the vehicle and the acceleration information of the vehicle without intervention of the rear ECU 41. Further, a signal line 62 of the wheel speed sensor 52 is not connected to the front ECU 40.

A signal line 60 of the stroke sensor 500 is directly connected to the rear ECU 41 (the interface circuit). The front ECU 41 does not exist in a route through which a signal of the master cylinder pressure sensor 500 is transmitted. The rear ECU 41 acquires pedal stroke information without intervention of the front ECU 40. The signal line 62 of the wheel speed sensor 52 is directly connected to the rear ECU 41 (the interface circuit). The front ECU 41 does not exist in a route through which a signal of the wheel speed sensor 52 is transmitted. The rear ECU 41 directly acquires wheel speed information about the wheels 10L, 10R, 11L, and 11R without intervention of the front ECU 40. Further, the signal line 63 of the acceleration sensor 53 and the signal line 64 of the yaw rate sensor 54) are not connected to the rear ECU 41. The rear ECU 41 acquires the yaw rate information of the vehicle and the acceleration information of the vehicle via the front ECU 40.

The front ECU 40 and the rear ECU 41 can control the hydraulic brake mechanism 30 and the electric brake mechanism 31 based on the above-described acquired signals, respectively. The ECUs 40 and 41 can function as a control apparatus for the vehicle by controlling the braking forces on the front wheels 10 and the rear wheels 11, respectively. More specifically, the front ECU 40 functions as a hydraulic brake control apparatus for controlling the braking forces on the front wheels 10. The rear ECU 41 and the sub ECU 42 function as an electric brake control apparatus for controlling the braking forces on the rear wheels 11. Due to this configuration, the ECUs 40 to 42 can perform various kinds of brake control. The brake control includes normal brake control, anti-lock brake control (ABS), traction control, brake control for controlling a motion of the vehicle, regenerative cooperative brake control, autonomous brake control, parking brake control, hill start aid control, and the like.

The normal brake control generates a braking force so as to realize a desired characteristic between the brake operation amount and a vehicle deceleration requested by the driver. The ABS is brake control for preventing a lock of a wheel due to the braking. If determining that a wheel speed of some wheel (the signal of the wheel speed sensor 52) significantly reduces with respect to an estimated vehicle body speed, the ABS determines that this wheel is locked, and reduces the braking force for this wheel. The vehicle body speed can be estimated by, for example, calculating an average value of the signals of the wheel speed sensors 52 with respect to the four wheels 10L, 10R, 11L, and 11R or selecting a maximum value among the signals of the wheel speed sensors 52 with respect to the four wheels 10L, 10R, 11L, and 11R. The traction control is brake control for preventing a driving slip of a wheel. The control of the motion of the vehicle includes vehicle behavior stabilization control such as electronic stability control (ESC). If the actual yaw rate significantly deviates from a yaw rate (a target yaw rate) of the vehicle that is expected based on the current acceleration/deceleration and steering angle (the signal of the steering angle sensor) of the vehicle, the ESC changes the braking forces for the left and right wheels to correct the actual yaw rate closer to the target yaw rate. The signal indicating the brake operation amount from the stroke sensor 500 or the like, or a signal indicating an amount of an operation on an accelerator pedal can be used as the acceleration/deceleration of the vehicle. The signal of the yaw rate sensor 54 can be used as the actual yaw rate, or a value estimated with use of any one of or a plurality of signals among the signal of the acceleration sensor 53 (the lateral acceleration), the signal of the wheel speed sensor 52, the signal of the steering angle sensor, and the like may be used as the actual yaw rate. The regenerative cooperative brake control generates such a braking force that a sum of this braking force and a regenerative braking force satisfies the vehicle deceleration requested by the driver. The autonomous brake control is brake control necessary to realize a function such as adaptive cruise control (maintaining a distance to the vehicle running ahead) and prevention of a collision. The hill start aid control is brake control for keeping the vehicle stopped to prevent the vehicle from slipping down at the time of, for example, a hill start.

In the following description, a flow of the braking force control performed by the front ECU 40 and the rear ECU 41 will be described with reference to FIGS. 3 to 10. FIG. 3 illustrates an overall flow of the braking force control performed by the front ECU 40 and the rear ECU 41 as a whole (for example, in cooperation with each other). This control is repeatedly performed per predetermined cycle.

In steps S1 to S3, the front ECU 40 and the rear ECU 41 determine whether no failure (abnormality) has occurred in the front wheel brake device 20 and the rear wheel brake device 21. The front ECU 40 can determine a failure in the front wheel brake device 20 (the front ECU 40 and the hydraulic brake mechanism 30) and the rear wheel brake device 21 (the rear ECU 41 and the electric brake device 210). The same also applies to the rear ECU 41. Now, a failure state of each of the brake devices 20 and 21 depends on a portion where the failure has occurred. For example, only one of the left and right wheels is under control in some cases, while both the left and right wheels are out of control but keep operable regarding the functions of, for example, acquiring the sensor information and exchanging information via the communication in other cases. Among the portions in the respective brake devices 20 and 21, the ECUs 40 and 41 realize the functions of, for example, driving the actuator, acquiring the sensor information, and communicating with another ECU in the respective brake devices 20 and 21 for the braking force control. Therefore, when an abnormality has occurred in the ECU 40 or 41, any of these functions cannot be fulfilled. Therefore, in the following description, suppose that the control is performed when an abnormality has occurred in the ECU 40 or 41 as the failure state of the brake device 20 or 21 for simplification of the description.

In step S1, the front ECU 40 and the rear ECU 41 determines whether the front wheel brake device 20 is normal. If the front wheel brake device 20 is normal, the processing proceeds to step S2. If the front wheel brake device 20 is in the failure state, the processing proceeds to step S3. In step S2, the front ECU 40 and the rear ECU 41 determines whether the rear wheel brake device 21 is normal. If the rear wheel brake device 21 is normal, the processing proceeds to step S4. If the rear wheel brake device 21 is in the failure state, the processing proceeds to step S5. In step S3, the front ECU 40 and the rear ECU 41 determines whether the rear wheel brake device 21 is normal. If the rear wheel brake device 21 is normal, the processing proceeds to step S6. If the rear wheel brake device 21 is in the failure state, the processing proceeds to step S7. In step S4, the front ECU 40 and the rear ECU 41 performs the all wheel braking force control corresponding to when the brake system 1 is normal. In step S5, the front ECU 40 and the rear ECU 41 performs the front wheel braking force control corresponding to when a failure has occurred in the rear wheel. In step S6, the front ECU 40 and the rear ECU 41 performs the rear wheel braking force control corresponding to when a failure has occurred in the front wheel. In step S7, the front ECU 40 and the rear ECU 41 stops the braking force control on the front and rear wheels.

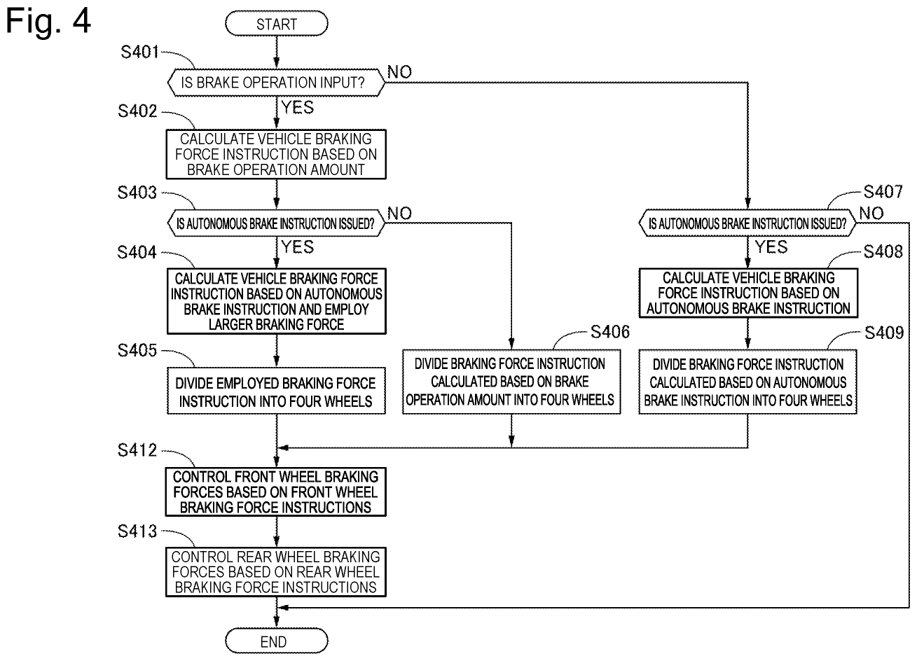

FIG. 4 illustrates a flow of the all wheel braking force control corresponding to when the brake system 1 is normal (step S4 in FIG. 3) that the front ECU 40 and the rear ECU 41 perform as a whole. This control is repeatedly performed per predetermined cycle. Any of the front ECU 40 and the rear ECU 41 may mainly perform steps S401 to S409.

In step S401, the front ECU 40 and the rear ECU 41 determines whether the brake operation is input. For example, whether the brake operation is input is determined based on whether the brake operation amount exceeds a predetermined value. If the brake operation is input, the processing proceeds to step S402. If the brake operation is not input, the processing proceeds to step S407. In step S402, the front ECU 40 and the rear ECU 41 calculates an instruction for the braking force on the vehicle that should be realized based on the detected brake operation amount. After that, the processing proceeds to step S403. In step S402, the front ECU 40 and the rear ECU 41 calculates the instruction for the braking force on the vehicle according to, for example, a characteristic that the braking force monotonously increases with respect to an increase in the brake operation amount. This instruction is expressed as a deceleration of the vehicle, a braking torque, or the like. Physical amounts of them are in a proportional relationship with the hydraulic pressure realized by the front wheel brake device 20 and the thrust force realized by the rear wheel brake device 21. Therefore, these hydraulic pressure and thrust force may be directly used as the instruction.

In step S403, the front ECU 40 and the rear ECU 41 determines whether the autonomous brake instruction is input. If the autonomous brake instruction is input, the processing proceeds to step S404. If the autonomous brake instruction is not input, the processing proceeds to step S406. The input of the autonomous brake instruction herein means that there is an instruction for autonomously braking the vehicle. More specifically, there is the instruction for autonomously braking the vehicle, for example, when the instruction for the autonomous brake control is transmitted from the other ECU 43, or when a condition for causing the hill start aid control to operate is determined to be satisfied with use of the signal of the wheel speed sensor 52, the signal of the acceleration sensor 53, and the like. In step S404, the front ECU 40 and the rear ECU 41 calculates the instruction for the braking force on the vehicle that should be realized based on the detected brake operation amount. After that, the processing proceeds to step S405. In step S404, the front ECU 40 and the rear ECU 41 compares the autonomous brake instruction and the instruction calculated in step S402, and employs a greater one of them as the braking force instruction.

In step S405, the front ECU 40 and the rear ECU 41 divides the braking force among the four wheels 10L, 10R, 11L, and 11R to realize the calculated braking force instruction. After that, the processing proceeds to step S412. In step S405, the front ECU 40 and the rear ECU 41 divides the braking force in consideration of the function such as the ABS and the ESC. As a result, the front ECU 40 and the rear ECU 41 can acquire the braking force instruction directed to each of the wheels 10L, 10R, 11L, and 11R necessary to realize the various kinds of brake control. For example, the front ECU 40 and the rear ECU 41 estimates the vehicle body speed with use of the signals of the wheel speed sensors 52 with respect to the front and rear wheels 10L, 10R, 11L, and 11R, and adjusts the division of the braking force among the four wheels 10L, 10R, 11L, and 11R so as to prevent the lock of the wheel based on the estimated vehicle body speed. Alternatively, the front ECU 40 and the rear ECU 41 detects or estimates the actual yaw rate with use of any one of or a plurality of signals among the signals of the yaw rate sensor 54, the acceleration sensor 53, the wheel speed sensor 52, and the steering angle sensor, and adjusts the division of the braking force among the four wheels 10L, 10R, 11L, and 11R so as to maintain the target yaw rate based on the detected or estimated actual yaw rate. In step S406, the front ECU 40 and the rear ECU 41 divides the braking force among the four wheels 10L, 10R, 11L, and 11R to realize the calculated braking force instruction in a similar manner to step S405. After that, the processing proceeds to step S412.

In step S407, the front ECU 40 and the rear ECU 41 determines whether the autonomous brake instruction is input in a similar manner to step S403. If the autonomous brake instruction is input, the processing proceeds to step S408. If the autonomous brake instruction is not input, the present control is ended. In step S408, the front ECU 40 and the rear ECU 41 calculates the instruction for the braking force on the vehicle that should be realized based on the detected brake operation amount. After that, the processing proceeds to step S409. In step S409, the front ECU 40 and the rear ECU 41 divides the braking force among the four wheels 10L, 10R, 11L, and 11R to realize the calculated braking force instruction in a similar manner to step S405. After that, the processing proceeds to step S412.

In step S412, the front ECU 40 controls the braking forces on the front wheels 10L and 10R based on the braking force instructions directed to the front wheels 10L and 10R among the divided braking force instructions directed to the individual wheels 10L, 10R, 11L, and 11R. After that, the processing proceeds to step S413. In step S412, the front ECU 40 drives the actuator (the motor 302 and the solenoid 303) while referring to the signal of the hydraulic sensor 50 in such a manner that the hydraulic pressure in the wheel cylinder 206 that is generated by the hydraulic brake mechanism 30 matches a result of converting the braking force instruction directed to each of the front wheels 10L and 10R into a hydraulic value. In step S413, the rear ECU 41 and the sub ECU 42 control the braking forces on the rear wheels 11L and 11R based on the braking force instructions directed to the rear wheels 11L and 11R among the divided braking force instructions directed to the individual wheels 10L, 10R, 11L, and 11R. After that, the present control is ended. In step S413, the rear ECU 41 and the sub ECU 42 drive the motor 311 while referring to the signals of the electric current sensor 512 and the thrust force sensor 513 in such a manner that the piston thrust force to be generated by the electric brake mechanism 31 matches a result of converting the braking force instruction directed to each of the rear wheels 11L and 11R into a piston thrust force value.

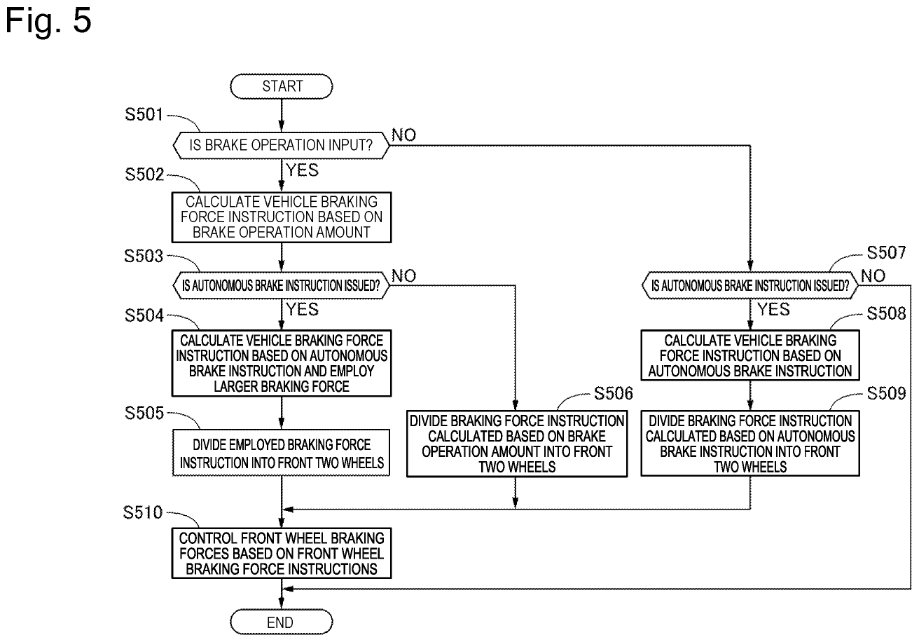

FIG. 5 illustrates a flow of the front wheel braking force control corresponding to when a failure has occurred in the rear wheel (step S5 in FIG. 3) that is performed by the front ECU 40. This control is repeatedly performed per predetermined cycle. Steps S501 to S504, S507, and S508 are similar to steps S401 to S404, S407, and S408 illustrated in FIG. 4, respectively. However, since the rear wheel brake device 21 is in the failure state, the front ECU 40 cannot acquire the signal of the stroke sensor 500 from the rear ECU 41. Therefore, the front ECU 40 uses the signal of the master cylinder pressure sensor 501 that is recognized by the front ECU 40 as the brake operation amount.

In steps S505, S506, and S509, the front ECU 40 divides the braking force between the front wheels 10L and 10R to realize the calculated braking force instruction of the vehicle. At this time, the braking force that should have been assigned to the rear wheels 11L and 11R in the all wheel braking force control corresponding to when the brake system 1 is normal is added to the braking force instructions directed to the front wheels 10L and 10R. The front ECU 40 divides the braking force in consideration of the function such as the ESC. As a result, the front ECU 40 can acquire the braking force instruction directed to each of the wheels 10L and 10R necessary to realize the various kinds of brake control. Since the rear wheel brake device 21 is in the failure state, the front ECU 40 cannot acquire the vehicle body speed information and cannot acquire the signal of the wheel speed sensor 52 from the rear ECU 41. Therefore, the front ECU 40 cannot acquire or estimate the vehicle body speed, and therefore refrains from performing the ABS control on the front wheels 10L and 10R. On the other hand, the front ECU 40 detects or estimates the actual yaw rate with use of any one of or a plurality of signals among the signals of the yaw rate sensor 54, the acceleration sensor 53, and the steering angle sensor that are acquired by the front ECU 40, and adjusts the division of the braking force between the front wheels 10L and 10R so as to maintain the target yaw rate based on this detected or estimated actual yaw rate with the aim of realizing the ESC function. In step S510, the front ECU 40 controls the braking forces on the front wheels 10L and 10R based on the assigned braking force instructions directed to the front wheels 10L and 10R. After that, the present control is ended.

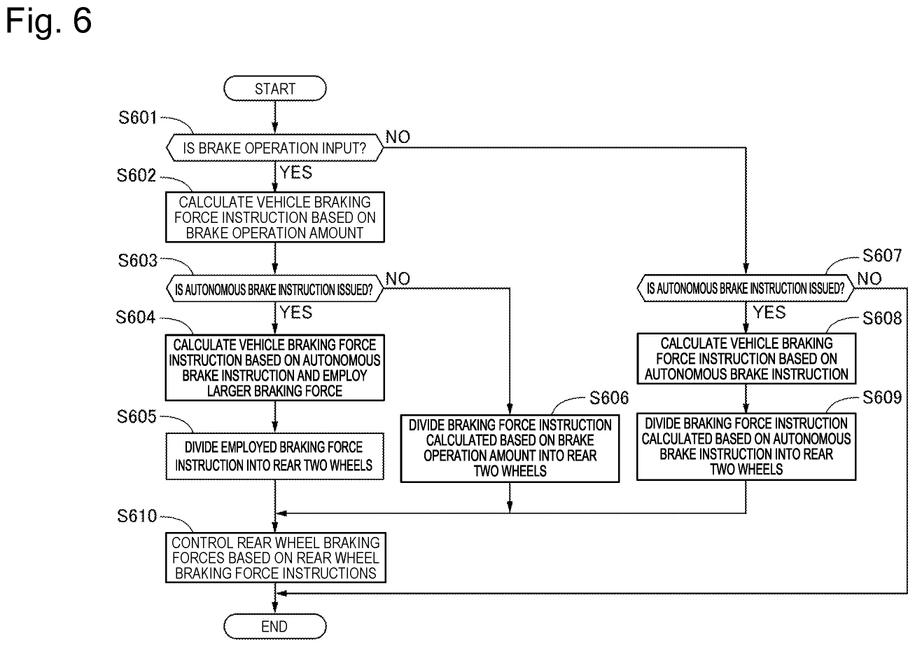

FIG. 6 illustrates a flow of the rear wheel braking force control corresponding to when a failure has occurred in the front wheel (step S6 in FIG. 3) that is performed by the rear ECU 41. This control is repeatedly performed per predetermined cycle. Steps S601 to S604, S607, and S608 are similar to steps S401 to S404, S407, and S408 illustrated in FIG. 4, respectively. However, since the front wheel brake device 20 is in the failure state, the rear ECU 41 cannot acquire the signal of the master cylinder pressure sensor 501 from the front ECU 40. Therefore, the rear ECU 41 uses the signal of the stroke sensor 500 that is recognized by the rear ECU 41 as the brake operation amount.

In steps S605, S606, and S609, the rear ECU 41 divides the braking force between the rear wheels 11L and 11R to realize the calculated braking force instruction of the vehicle. At this time, even in the failure state, the front wheel brake device 20 can generate the hydraulic pressure in the wheel cylinder 206 with use of the pedal pressing force when the brake pedal 201 is operated, and this is realized as the braking force. Therefore, the rear ECU 41 may estimate the hydraulic pressure in the wheel cylinder 206 that is generated on each of the front wheels 10L and 10R based on the brake operation amount, and subtract the braking force corresponding thereto from the braking force instructions directed to the rear wheels 11L and 11R. The rear ECU 41 divides the braking force in consideration of the function such as the ABS and the ESC. As a result, the rear ECU 41 can acquire the braking force instruction directed to each of the wheels 11L and 11R necessary to realize the various kinds of brake control. For example, the rear ECU 41 estimates the vehicle body speed with use of the signals of the wheel speed sensors 52 with respect to the front and rear wheels 10L, 10R, 11L, and 11R that are acquired by the rear ECU 41, and adjusts the division of the braking force between the rear wheels 11L and 11R so as to prevent the lock of the rear wheels 11L and 11R based on the estimated vehicle body speed. On the other hand, since the front wheel brake device 20 is in the failure state, the rear ECU 41 cannot acquire the signals of the yaw rate sensor 54 and the acceleration sensor 53 from the front ECU 40. Therefore, the rear ECU 41 estimates the actual yaw rate with use of the signal of the wheel speed sensor 52 that is acquired by the rear ECU 41, and adjusts the division of the braking force between the rear wheels 11L and 11R so as to maintain the target yaw rate based on this estimated actual yaw rate. In step S610, the rear ECU 41 controls the braking forces on the rear wheels 11L and 11R based on the assigned braking force instructions directed to the rear wheels 11L and 11R. After that, the present control is ended.

Next, advantageous effects will be described. Conventionally, there has been known a brake system including a front wheel brake device and a rear wheel brake device. The front wheel brake device includes a hydraulic brake mechanism and a first controller (the front ECU) capable of controlling the hydraulic brake mechanism. The rear wheel brake device includes an electric brake mechanism and a second controller (the rear ECU) capable of controlling the electric brake mechanism. This brake system is employed for a vehicle including a wheel speed sensor capable of detecting a wheel speed of each wheel and a vehicle body speed sensor capable of detecting a vehicle body speed of the vehicle. The wheel speed sensor that detects a wheel speed of a front wheel is connected to the front ECU, and the wheel speed sensor that detects a wheel speed of a rear wheel is connected to the rear ECU. The brake system is configured in such a manner that each of the front ECU and the rear ECU can acquire the vehicle body speed information detected by the vehicle body speed sensor. In this system, when an abnormality has occurred in the front wheel brake device or the rear wheel brake device, with use of the vehicle body speed information and the wheel speed information of the wheel for which this ECU itself is in charge of the braking force control, the ECU of the brake device on a normal side on which the abnormality has not occurred can apply the braking force to this wheel so as to prevent the lock of this wheel (the ABS function). As a result, the brake system can brake the vehicle so as to prevent a rotational moment from occurring on the vehicle.

However, some of recent vehicles are equipped with an acceleration sensor and a yaw rate sensor instead of the vehicle body speed sensor to realize the ESC function. In this case, for example, an average value of the wheel speed information of the four wheels should be substituted for the vehicle body speed information used to realize the ABS function. In the case where the above-described conventional brake system is employed for such a vehicle, when the brake operation is performed with an abnormality having occurred in the front brake device or the rear brake device, the ECU of the brake device on the normal side on which the abnormality has not occurred can acquire only the wheel speeds of two wheels, thereby failing to estimate the vehicle body speed. This may bring about such a situation that the braking force is generated in a state that the lock is also unavoidable with respect to the wheel on which the braking force can be controlled (by the ECU on the normal side on which the abnormality has not occurred). Especially in the autonomous brake function, the instruction for generating the braking force is calculated independently of the brake operation, and therefore it is difficult to stabilize the behavior of the vehicle by the driver's brake operation or operation on the steering wheel. Therefore, the autonomous brake function cannot continue in the state that the lock is unavoidable in the above-described manner.

On the other hand, in the brake system (the brake apparatus) 1 according to the present embodiment, the signal line 64 of the yaw rate sensor 54, which measures the yaw rate of the vehicle, and the signal line 63 of the acceleration sensor 53, which measures the acceleration of the vehicle, are connected to the front ECU 40. Further, the signal line 62 of the wheel speed sensor 52, which measures the wheel speed of each of the front and rear wheels 10 and 11 (the plurality of wheels 10L, 10R, 11L, and 11R), is connected to the rear ECU 41 (the interface circuit). Therefore, even when the abnormality has occurred in the front wheel brake device 20 or the rear wheel brake device 21 and this makes the braking forces controllable at only any of the front wheels 10 and the rear wheels 11, the brake system 1 can brake the vehicle while stabilizing the behavior of the vehicle. That is, the rear ECU 41 acquires the wheel speed information of the front and rear wheels 10 and 11 via the signal line 62 (directly) without intervention of the front ECU 40. Therefore, even when the abnormality has occurred in the front wheel brake device 20 (for example, the front ECU 40), the rear ECU 41 can acquire the wheel speed information of the front and rear wheels 10 and 11, thereby estimating the vehicle body speed with use of this wheel speed information of the front and rear wheels 10 and 11. Therefore, the rear ECU 41 can apply the braking forces to the rear wheels 11 while preventing the rear wheels 11 from being locked (the ABS function). Therefore, the brake system 1 can brake the vehicle while stabilizing the behavior thereof. Further, the front ECU 40 acquires the yaw rate information of the vehicle and the acceleration information of the vehicle via the signal lines 63 and 64 directly without intervention of the rear ECU 41. Therefore, even when the abnormality has occurred in the rear wheel brake device 21 (for example, the rear ECU 41), the front ECU 40 can estimate the behavior of the vehicle body with use of at least any one of the yaw rate information of the vehicle and the acceleration information of the vehicle. Therefore, the brake system 1 can brake the vehicle while stabilizing the behavior of the vehicle by adjusting the braking forces on the front left and right wheels 10L and 10R (the ESC function). Further, even without the brake operation performed (for example, at the time of the autonomous brake), the brake system 1 can automatically brake the vehicle while stabilizing the behavior of the vehicle, and therefore the autonomous brake function can continue even when the abnormality has occurred.

The above-described advantageous effects can be achieved as long as at least any one of the signal line 63 of the acceleration sensor 53 and the signal line 64 of the yaw rate sensor 54 is connected to the front ECU 40. The front ECU 40 can estimate the behavior of the vehicle with use of the information of any of the sensors 53 and 54. For example, the brake system 1 may be configured in such a manner that the signal line 64 is not connected to the front ECU 40 while the signal line 63 is connected to the front ECU 40. Further, the front ECU 40 may be unable to acquire the longitudinal acceleration of the vehicle while being able to acquire the lateral acceleration of the vehicle. The front ECU 40 can estimate the actual yaw rate with use of the lateral acceleration information of the vehicle. Further, the above-described advantageous effects can be achieved as long as the sensor 53 and the like are connected to the front ECU 40 without intervention of the rear ECU 41, and the sensor 53 and the like do not necessarily have to be directly connected to the front ECU 40. For example, the brake system 1 may be configured in such a manner that the sensor 53 and the like are connected to an ECU different from the front ECU 40 and the rear ECU 41, and the front ECU 40 acquires the signals of the sensor 53 and the like from this different ECU via communication. In the present embodiment, the front ECU 40 is connected to the sensor 53 and the like without intervention of any ECU, and is therefore free from the possibility of becoming unable to acquire the signals of the sensor 53 and the like due to a failure in the intermediating ECU. Further, the front ECU 40 is directly connected to the sensor 53 and the like, thereby being able to improve responsiveness regarding the braking force control using the signals of these sensors 53 and the like.

Further, the above-described advantageous effects can be achieved as long as the wheel speed sensor 52 is connected to the rear ECU 41 without intervention of the front ECU 40, and the wheel speed sensor 52 does not necessarily have to be directly connected to the rear ECU 41. For example, the brake system 1 may be configured in such a manner that the wheel speed sensor 52 is connected to an ECU different from the front ECU 40 and the rear ECU 41 (for example, the sub ECU 42), and the rear ECU 41 acquires the signal of the wheel speed sensor 52 from this different ECU via communication. In the present embodiment, the rear ECU 41 is connected to the sensor 52 without intervention of any ECU, and is therefore free from the possibility of becoming unable to acquire the signal of the sensor 52 due to a failure in the intermediating ECU. Further, the rear ECU 41 is directly connected to the sensor 52, thereby being able to improve responsiveness regarding the braking force control using the signal of the sensor 52. The above-described advantageous effects can be achieved as long as the rear ECU 41 can acquire at least any one of the yaw rate information of the vehicle and the acceleration information of the vehicle (via the front ECU 40). The rear ECU 41 can estimate the behavior of the vehicle with use of any of the pieces of information. For example, the rear ECU 41 may be unable to acquire the yaw rate information of the vehicle while being able to acquire the lateral acceleration of the vehicle. Further, the rear ECU 41 may be unable to acquire the longitudinal acceleration of the vehicle while being able to acquire the lateral acceleration of the vehicle. The rear ECU 41 can estimate the actual yaw rate with use of the lateral acceleration information of the vehicle.

The rear ECU 41 may acquire the signal of the yaw rate sensor 54 or the signal of the acceleration sensor 53 via the CAN 610 (without the intervention of the front ECU 40). In the present embodiment, the rear ECU 41 acquires these signals via the dedicated communication line 611, thereby being able to improve responsiveness regarding the braking force control using the signal of the yaw rate sensor 54 or the acceleration sensor 53. Further, the signal line 63 or 64 of the yaw rate sensor 54 or the acceleration sensor 53 may also be connected to the rear ECU 41. In the present embodiment, the signal line 63 or 64 of the yaw rate sensor 54 or the acceleration sensor 53 is not connected to the rear ECU 41 (the interface circuit). Therefore, the present embodiment can prevent complication of the wiring. Further, the signal line 62 of the wheel speed sensor 52 that measures the wheel speed of any of the front and rear wheels 10 and 11 may also be connected to the front ECU 40. In the present embodiment, the signal line 62 of the wheel speed sensor 52, which measures the wheel speed of each of the front and rear wheels 10 and 11, is not connected to the front ECU 40. Therefore, the present embodiment can prevent complication of the wiring. Mounting the combined sensor 55 on the substrate of the front ECU 40 can contribute to simplifying the signal lines 63 and 64 connecting the sensors 53 and 54 and the front ECU 40 to each other, respectively.

The above-described advantageous effects, such as being able to brake the vehicle while stabilizing the behavior of the vehicle even when the abnormality has occurred, can be acquired as long as the brake system 1 is configured in such a manner that the controller of any one of the front wheels and the rear wheels can acquire the wheel speed signals of the plurality of wheels without intervention of another controller and the controller of the other of the front wheels and the rear wheels can acquire at least any one of the yaw rate information of the vehicle and the acceleration information of the vehicle. Now, the plurality of wheels means such a wheel group that the vehicle body speed can be estimated with use of the wheel speeds thereof, and refers to, for example, a wheel group including at least all driven wheels, and preferably, a wheel group including all the wheels. For example, the signal line 62 of the wheel speed sensor 52, which measures the wheel speed of each of the front and rear wheels 10 and 11, may be connected to the front ECU 40, and at least any one of the signal line 64 of the yaw rate sensor 54 and the signal line 63 of the acceleration sensor 53 may be connected to the rear ECU 41. In this case, when the abnormality has occurred in the front wheel brake device 20, the rear ECU 41 can realize the ESC function with respect to the rear wheels 11 by using at least one of the yaw rate information of the vehicle and the acceleration information of the vehicle. When the abnormality has occurred in the rear wheel brake device 21, the front ECU 40 can realize the ABS function with respect to the front wheels 10L and 10R by using the wheel speed information of the front and rear wheels 10 and 11. Therefore, the brake system 1 can brake the vehicle while stabilizing the behavior thereof. Similarly, the above-described advantageous effects can be acquired as long as the brake system 1 is configured in such a manner that the controller that controls the braking forces on any of the front left and right wheels and on any of the rear left and right wheels can acquire the wheel speed signals of the plurality of wheels without intervention of another controller and the controller that controls the braking forces on the remaining wheels can acquire at least any one of the yaw rate information of the vehicle and the acceleration information of the vehicle. To satisfy this configuration, in the present embodiment, the controller (the rear ECU 41) on the rear wheel side acquires the wheel speed signals of the plurality of wheels 10 and 11 without intervention another controller. Therefore, the brake system 1 can realize the ABS function even when the abnormality has occurred on the rear wheels 11 on which the lock more likely occurs than on the front wheels 10, thereby being able to brake the vehicle while stabilizing the behavior of the vehicle. When the abnormality has occurred in the rear wheel brake device 21 (the rear ECU 41), the front ECU 40 cannot acquire the wheel speed information, thereby being unable to estimate the vehicle body speed (unable to realize the ABS function). However, in a general passenger vehicle, a vertical load is heavier on the front wheel side than on the rear wheel side, and therefore the front wheels 10 are less likely locked in a range of deceleration realized as normal braking. Even if the front wheels 10 are locked, the brake system 1 can brake the vehicle while stabilizing the behavior of the vehicle (the ESC function) by adjusting the braking forces on the front left and right wheels 10L and 10R as described above.

The brake system 1 may include an electric brake mechanism as the front wheel brake device 20 and a hydraulic brake mechanism as the rear wheel brake device 21. In the present embodiment, the front wheel brake device 20 includes the hydraulic brake mechanism 30. Therefore, even when the abnormality has occurred in the front wheel brake device 20, the hydraulic braking forces can be applied to the front wheels 10 according to the pedal pressing force. The brake system 1 can brake the vehicle while stabilizing the behavior of the vehicle by being configured to be able to apply the hydraulic braking forces according to the pedal pressing force to the front wheels 10 on which the lock less likely occurs than on the rear wheels 11.

The stroke sensor 500 (the signal line 60 thereof) is connected to the rear ECU 41. Therefore, even when the abnormality has occurred in the front wheel brake device 20 (the front ECU 40), the rear ECU 41 can appropriately perform the various kinds of brake control with use of the brake operation information (the brake operation amount) acquired from the stroke sensor 500. For example, even when the abnormality has occurred in the front wheel brake device 20 (the front ECU 40), the rear ECU 41 can estimate the hydraulic braking forces to apply to the front wheels 10 according to the pedal pressing force with use of the information about the brake operation amount acquired from the stroke sensor 500. Therefore, the rear ECU 41 can apply further appropriate braking forces to the rear wheels 11 by controlling the braking forces on the rear wheels 11 in consideration of the hydraulic braking forces on the front wheels 10. Further, the above-described advantageous effects can be achieved as long as the stroke sensor 500 is connected to the rear ECU 41 without intervention of the front ECU 40, and the stroke sensor 500 does not necessarily have to be directly connected to the rear ECU 41. For example, the brake system 1 may be configured in such a manner that the stroke sensor 500 is connected to an ECU different from both the front ECU 40 and the rear ECU 41, and the rear ECU 41 acquires the signal of the stroke sensor 500 from this ECU via communication. In the present embodiment, the stroke sensor 500 is directly connected to the rear ECU 41, and therefore the brake operation information can be further quickly acquired.

The master cylinder pressure sensor 501 is connected to the front ECU 40. Therefore, even when the abnormality has occurred in the rear wheel brake device 21 (the rear ECU 41), the front ECU 40 can appropriately perform the various kinds of brake control with use of the information about the brake operation amount acquired from the master cylinder pressure sensor 501. The above-described advantageous effects can be achieved as long as the master cylinder pressure sensor 501 is connected to the front ECU 40 without intervention of the rear ECU 41, and the master cylinder pressure sensor 501 does not necessarily have to be directly connected to the front ECU 40. For example, the brake system 1 may be configured in such a manner that the master cylinder pressure sensor 501 is connected to an ECU different from both the front ECU 40 and the rear ECU 41, and the front ECU 40 acquires the signal of the master cylinder pressure sensor 501 from this ECU via communication.

In the present embodiment, the rear wheel brake device 21 is not “configured in such a manner that the driver's brake operation force (the pedal pressing force and the like) is directly applied to the wheels as the braking forces when the braking forces cannot be increased on the control wheels that this brake device is in charge of due to a failure in the ECU or the like”, unlike the front wheel brake device 20. Therefore, the rear wheel brake device 21 can apply appropriate braking forces to the rear wheels 11 with use of the signal from the brake operation amount detection unit while applying the braking forces to the front wheels 10 according to the brake operation force when the abnormality has occurred in the front wheel brake device 20, due to the connection of the brake operation amount detection unit (the stroke sensor 500) to the controller (the rear ECU 41) of the rear wheel brake device 21. Therefore, the brake system 1 can brake the vehicle while stabilizing the behavior thereof. The brake operation amount detection unit may be connected to any of the ECUs 40 and 41 as long as the rear wheel brake device 21 is configured in the above-described manner. On the other hand, it is preferable that the brake operation amount detection unit is connected to both the ECUs 40 and 41 of the brake devices 20 and 21, if the front wheel brake device 20 is also “configured in such a manner that the driver's brake operation force is not directly applied to the wheels as the braking forces when the braking forces cannot be increased on the control wheels that this brake device is in charge of due to a failure in the ECU or the like” similarly to the rear wheel brake device 21. In this case, the output of the single detection unit may be branched to two destinations, or a plurality of detection units may be used.

The controller of the rear wheel brake device 21 according to the present embodiment includes the rear ECU 41 and the sub ECU 42. Therefore, the present embodiment can simplify the configurations of the rear ECU 41 and the communication line 612.

### EXAMPLES

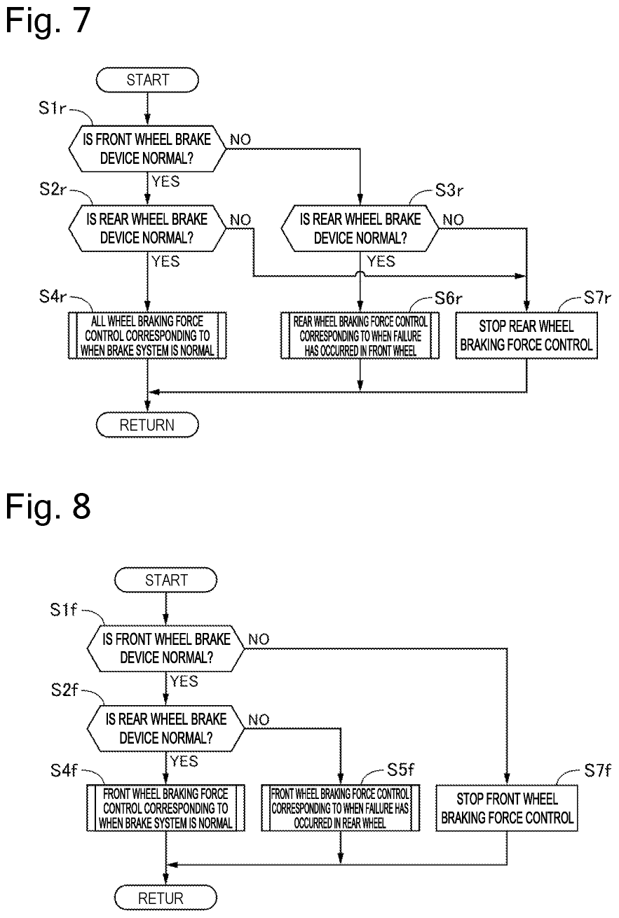

FIGS. 7 to 10 illustrate one example of the division of the processing between the front ECU 40 and the rear ECU 41 according to the present embodiment. In the present example, the rear ECU 41 mainly performs the all wheel braking force control corresponding to when the brake system 1 is normal (FIG. 4). The processing may be divided in any manner as long as the processing illustrated in FIGS. 3 and 4 can be realized as a whole with use of the communication between these ECUs 40 and 41, and the method for dividing the processing is not limited to the present example.

FIG. 7 illustrates the processing in the overall flow of the braking force control that is assigned to and performed by the rear ECU 41. This control is repeatedly performed per predetermined cycle. Steps S1r, S2r, S3r, and S6r are similar to steps S1, S2, S3, and S6 illustrated in FIG. 3, respectively. If the rear ECU 41 determines that the rear wheel brake device 21 is in the failure state in step S2r, the processing proceeds to step S7r. In step S7r, the rear ECU 41 stops the braking force control on the rear wheels 11L and 11R.

FIG. 8 illustrates the processing in the overall flow of the braking force control that is assigned to and performed by the front ECU 40. This control is repeatedly performed per predetermined cycle. Steps S1f, S2f, and S5f are similar to steps S1, S2, and S5 illustrated in FIG. 3, respectively. If the front ECU 40 determines that the front wheel brake device 20 is in the failure state in step S1f, the processing proceeds to step S7f. In step S7f, the front ECU 40 stops the braking force control on the front wheels 10L and 10R.

Step S4r in FIG. 7 and step S4f in FIG. 8, and step S7r in FIG. 7 and step S7f in FIG. 8 are performed in synchronization with each other, respectively.

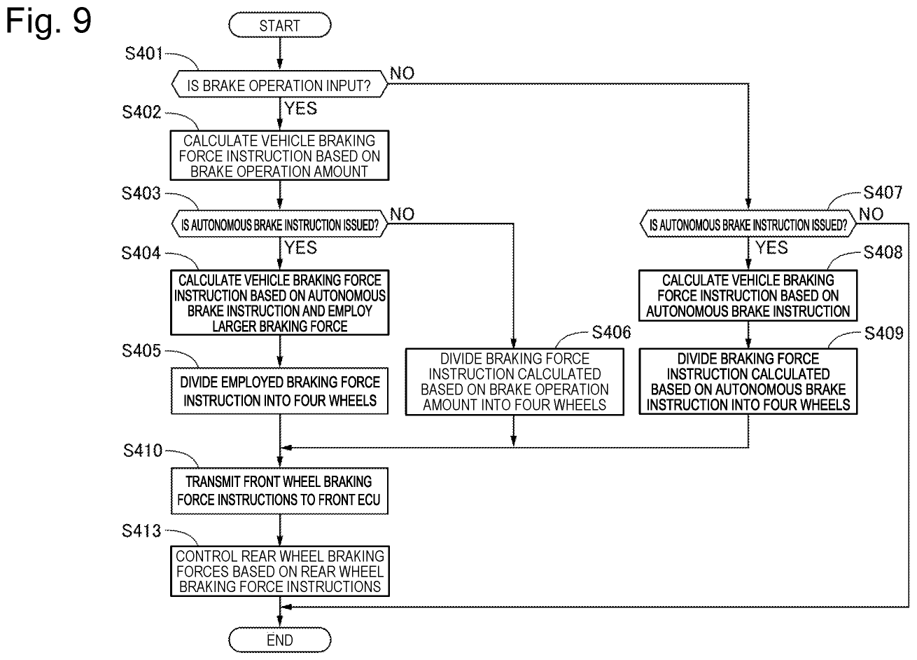

FIG. 9 illustrates the processing in the flow of the all wheel braking force control corresponding to when the brake system 1 is normal that is assigned to and performed by the rear ECU 41 (step S4r in FIG. 7). This control is repeatedly performed per predetermined cycle. FIG. 9 is similar to FIG. 4, and therefore will be described focusing only on characteristic features thereof. In steps S405, S406, and S409, the rear ECU 41 uses the value recognized by the front ECU 40 and acquired by the rear ECU 41 via the communication as the acceleration information and the yaw rate information of the vehicle for use in the division of the braking force among the four wheels 10L, 10R, 11L, and 11R. Step S410 is performed instead of step S412 in FIG. 4. In step S410, the rear ECU 41 transmits the instructions directed to the front wheels 10L and 10R among the braking force instructions assigned to the four wheels 10L, 10R, 11L, and 11R to the front ECU 40 via the communication.

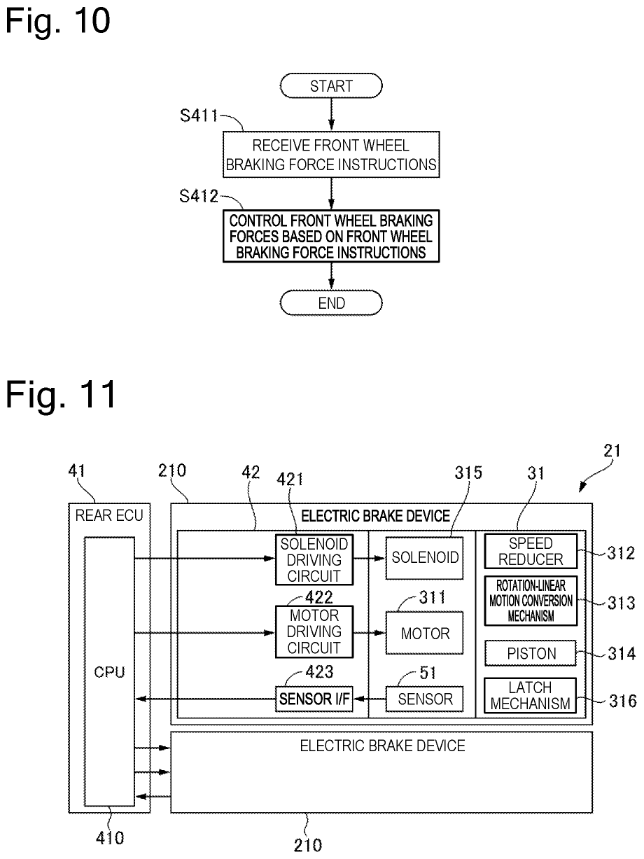

FIG. 10 illustrates the processing in the flow of the all wheel braking force control corresponding to when the brake system 1 is normal that is assigned to and performed by the front ECU 40 (step S4f in FIG. 8). This control is repeatedly performed per predetermined cycle. In step S411, the front ECU 40 receives the braking force instructions directed to the front wheels 10L and 10R transmitted from the rear ECU 41. In step S412, the front ECU 40 controls the braking forces on the front wheels 10L and 10R based on the received braking force instructions directed to the front wheels 10L and 10R.

In other words, the rear ECU 41 serves the functions of calculating the braking force instruction of the vehicle and dividing the braking force among the four wheels 10L, 10R, 11L and 11R. The CPU 410 of the rear ECU 41 includes a calculator. This calculator functions as a calculation portion that can calculate (determine) the division between the braking forces to apply to the front wheels 10 and the braking forces to apply to the rear wheels 11. The rear ECU 41 can transmit the signals indicating the braking forces assigned to the front wheels 10 that are calculated by the calculator to the front ECU 40 via the signal line 611.

Next, advantageous effects according to the present example will be described. The rear ECU 41 can determine the division among the braking forces to apply to the front wheels 10 and the braking forces to apply to the rear wheels 11 (steps S405, S406, and S409), and transmit the signals indicating the braking forces assigned to the front wheels 10 to the front ECU 40 (the step S410). The braking force is divided among the four wheels 10L, 10R, 11L, and 11R (steps S405, S406, and S409) in consideration of the functions such as the ABS and ESC, by which the various kinds of brake control are realized. The ABS control should be realized quickly compared to the other kinds of brake control. The ABS control uses the wheel speed sensor signals of the front and rear wheels 10 and 11. The rear ECU 41, which can directly recognize the wheel speed sensor signals of the front and rear wheels 10 and 11, mainly performs the all wheel braking force control (the division of the braking force) corresponding to when the brake system 1 is normal, thereby being able to realize the ABS control quickly. Further, the rear ECU 41 controls the braking forces on the rear wheels 11 as the rear wheel brake device 21. The brake system 1 can realize the ABS function quickly on the rear wheels 11 on which the lock more likely occurs than on the front wheels 10, thereby being able to brake the vehicle while stabilizing the behavior of the vehicle.

### Second Embodiment

A configuration of a control system of a rear wheel brake device 21 according to the present embodiment will be described with reference to FIG. 11. Similarly to the first embodiment, the rear wheel brake device 21 is configured in such a manner that each of the electric brake devices 210 of the rear wheels 11L and 11R includes the driving circuits 421 and 423. However, the rear wheel brake device 21 includes a single CPU, and only the rear ECU 41 is equipped with the CPU 410 with no CPU provided to each of the electric brake devices 210 (the sub ECUs 42). The CPU 410 has a function as a combination of the CPU 410 (superior) and the CPU 420 (subordinate) according to the first embodiment. Therefore, each of the sub ECUs 42 (the electric brake devices 210) can be simplified compared to the first embodiment. The other configurations and advantageous effects are similar to the first embodiment.

### Third Embodiment

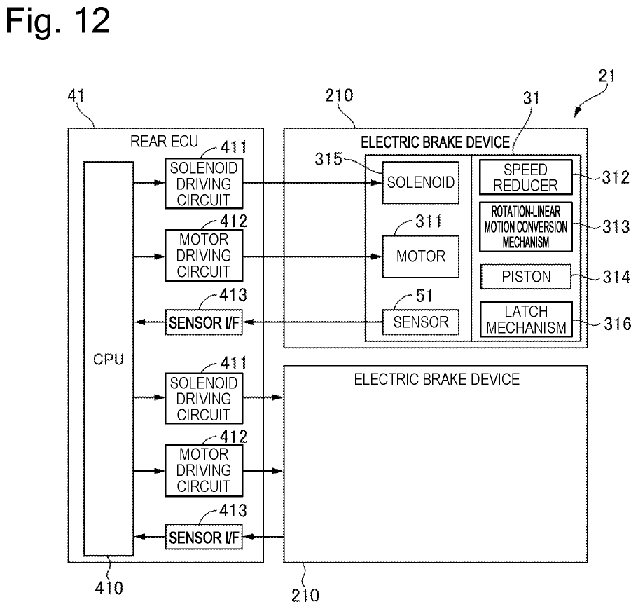

A configuration of a control system of a rear wheel brake device 21 according to the present embodiment will be described with reference to FIG. 12. The control system is configured not to include the sub ECU 42 in each of the electric brake devices 210 of the rear wheels 11L and 11R. The rear wheel brake device 21 includes a single CPU, and only the rear ECU 41 is equipped with the CPU 410 (similarly to the second embodiment). The wiring leading to the motor 311, the wiring leading to the solenoid 315, and the signal line of the sensor 51 of each of the electric brake mechanisms 31 of the rear wheels 11L and 11R are connected to the rear ECU 41. The rear ECU 41 includes two sets of driving circuits 411 and 412 and interface circuits 413 in correspondence with the respective electric brake devices 210 (the electric brake mechanisms 31) of the rear wheels 11L and 11R. The CPU 410 outputs the instruction signal according to the braking force instruction directed to each of the wheels 11L and 11R to each of the above-described sets of the driving circuits 411 and 412. Therefore, each of the electric brake devices 210 can be simplified compared to the first embodiment and the second embodiment. The other configurations and advantageous effects are similar to the first embodiment.

[Other Configurations Recognizable from Embodiments]

In the following description, other configurations recognizable from the above-described embodiments will be described.

(1) A brake apparatus, according to one configuration thereof, includes a hydraulic brake mechanism capable of applying a braking force by thrusting a braking member forward with use of a hydraulic pressure to a wheel belonging to a first group among a plurality of wheels of a vehicle, an electric brake mechanism capable of applying a braking force by thrusting a braking member forward with use of an electric motor to a wheel belonging to a second group different from the first group among the plurality of wheels, a first controller capable of controlling the hydraulic brake mechanism, and a second controller capable of controlling the electric brake mechanism. The first controller acquires or receives at least one of yaw rate information of the vehicle and acceleration information of the vehicle without intervention of the second controller. The second controller acquires or receives wheel speed information of the plurality of wheels without intervention of the first controller.
(2) According to another configuration, in the above-described configuration, the brake apparatus further includes an operation amount detector configured to detect an operation amount of a brake operation member. The operation amount detector is connected to the second controller.
(3) According to another configuration, in any of the above-described configurations, the second controller is connected communicably with the first controller. The second controller can determine how to divide a braking force into the braking force to apply to the wheel belonging to the first group and the braking force to apply to the wheel belonging to the second group, and transmit a signal indicating the braking force assigned to the wheel belonging to the first group.
(4) Further, from another aspect, a control apparatus for a vehicle, according to one configuration thereof, includes a first control circuit configured to control a hydraulic brake mechanism capable of applying a braking force by thrusting a braking member forward with use of a hydraulic pressure to a wheel belonging to a first group among a plurality of wheels, and a second control circuit configured to control an electric brake mechanism capable of applying a braking force by thrusting a braking member forward with use of an electric motor to a wheel belonging to a second group different from the first group among the plurality of wheels. A signal line of a wheel speed measurement portion is not connected to the first control circuit, and at least one of a signal line of a yaw rate measurement portion and a signal line of an acceleration measurement portion is connected to the first control circuit. The wheel speed measurement portion is configured to measure wheel speeds of the plurality of wheels. The yaw rate measurement portion is configured to measure a yaw rate of the vehicle. The acceleration measurement portion is configured to measure an acceleration of the vehicle. The signal line of the yaw rate measurement portion and the signal line of the acceleration measurement portion are not connected to the second control circuit, and the signal line of the wheel speed measurement portion is connected to the second control circuit. The wheel speed measurement portion is configured to measure the wheel speeds of the plurality of wheels.
(5) According to another configuration, in the above-described configuration, a signal line of an operation amount measurement portion is connected to the second control circuit. The operation amount measurement portion is configured to measure an operation amount of a brake operation member.
(6) According to another configuration, in any of the above-described configurations, the second control circuit includes a calculation portion capable of calculating how to divide a braking force into the braking force to apply to the wheel belonging to the first group and the braking force to apply to the wheel belonging to the second group. A signal line for transmitting a signal indicating the braking force assigned to the wheel belonging to the first group, which is calculated by the calculation portion, to the first control circuit, is connected to the second control circuit.
(7) Further, from another aspect, an electric brake control apparatus, according to one configuration thereof, is configured to be used to control an electric brake mechanism capable of applying a braking force by thrusting a braking member forward with use of an electric motor to a wheel belonging to a second group among a plurality of wheels of a vehicle including wheels belonging to a first group and the second group different from each other. The electric brake control apparatus directly acquires or receives wheel speed information of the plurality of wheels. The electric brake control apparatus acquires or receives at least acceleration information of the vehicle via another brake control apparatus for controlling a braking force on the wheel belonging to the first group.
(8) According to another configuration, in the above-described configuration, the electric brake control apparatus can determine how to divide a braking force into the braking force to apply to the wheel belonging to the first group and the braking force to apply to the wheel belonging to the second group, and transmit a signal indicating the braking force assigned to the wheel belonging to the first group to the other brake control apparatus.
(9) Further, from another aspect, an electric brake control apparatus, according to one configuration thereof, is configured to be used to control an electric brake mechanism capable of applying a braking force by thrusting a braking member forward with use of an electric motor to a wheel belonging to a second group among a plurality of wheels of a vehicle including wheels belonging to a first group and the second group different from each other. The electric brake control apparatus includes a control circuit including a calculator. A wiring leading to the electric motor is connected to the control circuit. A signal line of a yaw rate measurement portion and a signal line of an acceleration measurement portion are not connected to the control circuit, and a signal line of a wheel speed measurement portion is connected to the control circuit. The yaw rate measurement portion is configured to measure a yaw rate of the vehicle. The acceleration measurement portion is configured to measure an acceleration of the vehicle. The wheel speed measurement portion is configured to measure wheel speeds of the plurality of wheels.

Having described several embodiments of the present invention, the above-described embodiments of the present invention are intended to only facilitate the understanding of the present invention, and are not intended to limit the present invention thereto. The present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority under the Paris Convention to Japanese Patent Application No. 2017-185740 filed on Sep. 27, 2017. The entire disclosure of Japanese Patent Application No. 2017-185740 filed on Sep. 27, 2017 including the specification, the claims, the drawings, and the abstract is incorporated herein by reference in its entirety.

### REFERENCE SIGNS LIST

1 brake apparatus
10 front wheel (wheel belonging to first group)
11 rear wheel (wheel belonging to second group)
201 brake pedal (brake operation member)
206 wheel cylinder (braking member)
30 hydraulic brake mechanism
31 electric brake mechanism
311 motor (electric motor)
314 piston (braking member)
40 front ECU (first controller, another brake control apparatus, first control circuit, control apparatus for vehicle)
41 rear ECU (second controller, electric brake control apparatus, second control circuit, control apparatus for vehicle)
410 CPU (calculator, calculation portion)
500 stroke sensor (operation amount detector, operation amount measurement portion)
52 wheel speed sensor (wheel speed measurement portion)
53 acceleration sensor (acceleration measurement portion)
54 yaw rate sensor (yaw rate measurement portion)
60 signal line
611 communication line
612 communication line
62 signal line
63 signal line
64 signal line

1. A brake apparatus comprising:
a hydraulic brake mechanism capable of applying a braking force by thrusting a braking member forward with use of a hydraulic pressure to a wheel belonging to a first group among a plurality of wheels of a vehicle;
an electric brake mechanism capable of applying a braking force by thrusting a braking member forward with use of an electric motor to a wheel belonging to a second group different from the first group among the plurality of wheels;
a first controller capable of controlling the hydraulic brake mechanism; and
a second controller capable of controlling the electric brake mechanism,
wherein the first controller acquires or receives at least one of yaw rate information of the vehicle and acceleration information of the vehicle without intervention of the second controller, and
wherein the second controller acquires or receives wheel speed information of the plurality of wheels without intervention of the first controller.

2. The brake apparatus according to claim 1, further comprising an operation amount detector configured to detect an operation amount of a brake operation member,
wherein the operation amount detector is connected to the second controller.

3. The brake apparatus according to claim 1, wherein the second controller is connected communicably with the first controller, and can determine how to divide a braking force into the braking force to apply to the wheel belonging to the first group and the braking force to apply to the wheel belonging to the second group, and transmit a signal indicating the braking force assigned to the wheel belonging to the first group.

4. A control apparatus for a vehicle, comprising:
a first control circuit configured to control a hydraulic brake mechanism capable of applying a braking force by thrusting a braking member forward with use of a hydraulic pressure to a wheel belonging to a first group among a plurality of wheels; and
a second control circuit configured to control an electric brake mechanism capable of applying a braking force by thrusting a braking member forward with use of an electric motor to a wheel belonging to a second group different from the first group among the plurality of wheels,
wherein a signal line of a wheel speed measurement portion is not connected to the first control circuit, and at least one of a signal line of a yaw rate measurement portion and a signal line of an acceleration measurement portion is connected to the first control circuit, the wheel speed measurement portion being configured to measure wheel speeds of the plurality of wheels, the yaw rate measurement portion being configured to measure a yaw rate of the vehicle, the acceleration measurement portion being configured to measure an acceleration of the vehicle, and
wherein the signal line of the yaw rate measurement portion and the signal line of the acceleration measurement portion are not connected to the second control circuit, and the signal line of the wheel speed measurement portion is connected to the second control circuit, the wheel speed measurement portion being configured to measure the wheel speeds of the plurality of wheels.

5. The control apparatus for the vehicle according to claim 4, wherein a signal line of an operation amount measurement portion is connected to the second control circuit, the operation amount measurement portion being configured to measure an operation amount of a brake operation member.

6. The control apparatus for the vehicle according to claim 4, wherein the second control circuit includes a calculation portion capable of calculating how to divide a braking force into the braking force to apply to the wheel belonging to the first group and the braking force to apply to the wheel belonging to the second group, and
wherein a signal line for transmitting a signal indicating the braking force assigned to the wheel belonging to the first group, which is calculated by the calculation portion, to the first control circuit, is connected to the second control circuit.

7. An electric brake control apparatus configured to be used to control an electric brake mechanism capable of applying a braking force by thrusting a braking member forward with use of an electric motor to a wheel belonging to a second group among a plurality of wheels of a vehicle including wheels belonging to a first group and the second group different from each other,
wherein the electric brake control apparatus directly acquires or receives wheel speed information of the plurality of wheels, and
wherein the electric brake control apparatus acquires or receives at least acceleration information of the vehicle via another brake control apparatus for controlling a braking force on the wheel belonging to the first group.

8. The electric brake control apparatus according to claim 7, wherein the electric brake control apparatus can determine how to divide a braking force into the braking force to apply to the wheel belonging to the first group and the braking force to apply to the wheel belonging to the second group, and transmit a signal indicating the braking force assigned to the wheel belonging to the first group to the other brake control apparatus.

9. An electric brake control apparatus configured to be used to control an electric brake mechanism capable of applying a braking force by thrusting a braking member forward with use of an electric motor to a wheel belonging to a second group among a plurality of wheels of a vehicle including wheels belonging to a first group and the second group different from each other,
the electric brake control apparatus comprising:
a control circuit including a calculator, a wiring leading to the electric motor being connected to the control circuit,
wherein a signal line of a yaw rate measurement portion and a signal line of an acceleration measurement portion are not connected to the control circuit, and a signal line of a wheel speed measurement portion is connected to the control circuit, the yaw rate measurement portion being configured to measure a yaw rate of the vehicle, the acceleration measurement portion being configured to measure an acceleration of the vehicle, the wheel speed measurement portion being configured to measure wheel speeds of the plurality of wheels.

10. The brake apparatus according to claim 2, wherein the second controller is connected communicably with the first controller, and can determine how to divide a braking force into the braking force to apply to the wheel belonging to the first group and the braking force to apply to the wheel belonging to the second group, and transmit a signal indicating the braking force assigned to the wheel belonging to the first group.

11. The control apparatus for the vehicle according to claim 5, wherein the second control circuit includes a calculation portion capable of calculating how to divide a braking force into the braking force to apply to the wheel belonging to the first group and the braking force to apply to the wheel belonging to the second group, and
wherein a signal line for transmitting a signal indicating the braking force assigned to the wheel belonging to the first group, which is calculated by the calculation portion, to the first control circuit, is connected to the second control circuit.
